(19) United States
(12) Patent Application Publication
(10) Pub. No.: US 2015/0042090 A1
(43) Pub. Date: Feb. 12, 2015

(54) HUB AND CONNECTOR ARRANGEMENT

(71) Applicant: AKER SUBSEA AS, Lysaker (NO)

(72) Inventors: Morten Rengman Mørck, Oslo (NO); Anders Rynning, Oslo (NO)

(21) Appl. No.: 14/380,907

(22) PCT Filed: Feb. 21, 2013
(86) PCT No.: PCT/NO2013/050034

§ 371 Date: Aug. 25, 2014

(30) Foreign Application Priority Data
Feb. 27, 2012 (NO) 20120210

(51) Int. Cl. F16L 23/18; F16L 23/04

(52) U.S. Cl. CPC F16L 23/18; F16L 23/04
USPC 285/368; 285/406

(57) ABSTRACT

A combined hub joint and connector arrangement for rigidly connecting two axially consecutive tubular members is shown. The tubular members have respective hub end surfaces to be mated, where each hub further includes a flanged end having an external tapered activation surface adapted for complementary engagement with an internal tapered activation surface of the connector, The activation surfaces are able to transform a transversally acting force, when viewed in the longitudinal direction of the joined hubs, to an axially acting force when the connector is activated to make up the joint. The hub end mating surfaces diverge at least over some area of said mating surfaces and opens up in a radially outwards direction. The connector can either be a clamp connector, collet connector or split ring connector.

### FIELD OF THE INVENTION

The present invention relates in general to piping systems, more particularly to the mechanical joints for interconnecting tubular members subjected to high pressures.

More precisely, the present invention relates to a combined hub joint and connector arrangement for rigidly connecting two axially consecutive tubular members having respective hub end surfaces to be mated, each hub further comprises a flange having an external tapered activation surface adapted for complementary engagement with an internal tapered activation surface of the connector, said activation surfaces being able to transform a transversally acting force, when viewed in the longitudinal direction of the joined hubs, to an axially acting force when the connector is activated to make up the joint.

A connector arrangement of the above described design is known from U.S. Pat. No. 4,640,530. Other examples of prior art are shown in U.S. Pat. No. 3,158,380A and US 2010/295298 A1.

In particular the present invention finds usage in a connecting arrangement for tubular members during onshore and offshore operations, such that static sealing under all load conditions, is ensured. This also ensures maximum utilization of the load capacity of the connecting system.

More particularly, the present invention relates to a connecting arrangement for tubular members according to the preamble of claim 1.

### TECHNICAL BACKGROUND OF THE INVENTION

In onshore and offshore operations, such as for hydrocarbon exploration and production, reservoir maintenance, application of tubular structures/pipes is very common. For example, risers are applied for guiding drill pipes and tools to the well bore and for draining mud, removed from the well bore to the surface.

Now, such tubular structures need to be of substantial length and as such they are made up by succession of pipes, the adjacent ends of which are connected and disconnected for raising and lowering purposes.

Over the years, it has been a challenge in onshore and offshore operations to connect and disconnect such pipes effectively so as to ensure no separation at adjoined ends. This is essential for smooth and uninterrupted operation.

The limiting design criteria for most connectors in re, is the load at which separation of the adjoining pipe ends occur. The separation load threshold/capacity is usually significantly lower than the bonding load applied by the connector. As separation occurs on the inner perimeter of the pipe ends, the sealing conditions are dynamic rather than static, as it ideally should be. This happens in conventional pipe connectors due to application of flat/parallel surfaces on the face of the pipe ends. Hence, complete utilisation of the load capacity of the connector is prevented at a given load, because separation is initiated at the inner perimeter of the adjoined ends, while pretension is still present at the outer perimeter. Hence, substantial portion of the connector capacity remains unutilized.

The above drawback in pipe connecting systems applied in onshore and offshore operations, remains a long lasting problem which is not substantially resolved and this is what the present invention proposes to solve.

Research in this area has not yielded substantially good results and the connectors/pipe joint systems known in this field, are not appropriately focused to solve the problem as stated hereinbefore.

The older U.S. Pat. No. 3,135,538 does teach flanges along pipe ends which radially diverge away from the inner perimeter of the pipe joint for achieving mechanical joint, which is leak proof against higher fluid pressure. However, this patent is not entirely focused on substantial utilization of the load capacity of the connector.

U.S. Pat. No. 5,230,540 discloses a flange ring for making flange joints between casings of aero engines/other turbo engines. The flange ring has a flange joint face and a flange rear face. The flange joint face has a radially extending flat portion at its radially inner circumference and a frusto-conical surface, at an angle to the radial plane of the flat portion. The flange rear face is parallel to the frusto-conical portion (FIG. 2A). This configuration facilitates creating a joint having a large line reaction force along the flat portion, thereby providing efficient sealing, even when tension forces in the casing are present.

The above patent is also not focused on substantial utilization of the load capacity of the connector or on increasing the load capacity of the connector and is not meant for on shore and off shore operations.

Accordingly, there is a long left need to develop a connecting system for securing tubular members by connecting adjacent ends thereof such that static sealing conditions and substantial utilization of the capacity of the connecting system is ensured.

The present invention meets the aforesaid long felt need and other needs associated therewith.

### OBJECTS OF THE INVENTION

It is the principal object of the present invention to provide a connecting system for securing tubular members such that the load carrying capacity of the connecting system is substantially increased.

It is another object of the present invention to provide a connecting system for securing tubular members by connecting adjacent ends thereof, such that static sealing conditions and substantial utilization of the load carrying capacity of the connecting system at any given load condition, are ensured.

It is another object of the present invention to provide a connecting system for securing tubular members, which is simple in construction and cost effective.

A further object of the present invention is to provide a connecting system for securing tubular members, such that no separation exists at adjoined ends thereof.

How the foregoing objects are achieved and some other advantageous features, still not disclosed in prior art will be clear from the following non-limiting description.

All through the specification including the claims, the words, “pipe”, “tubular members”, “gasket”, “connector”, “clamp”, “flanges”, “hydrocarbon(including oil and gas)”, “on shore”, “off shore” are to be interpreted in the broadest sense of the respective terms and includes all similar items in the field known by other terms, as may be clear to persons skilled in the art. Restriction/limitation, if any, referred to in the specification, is solely by way of example and understanding the present invention.

In the above context it is also clarified that the present invention is applicable in respect of all types of pipes/tubular members/cylindrical fabrications as known to persons skilled in the art and references to “pipes”, “tubular members” in this specification are non-limiting and exemplary. Further, hereinbefore and hereinafter the present invention has been described with reference to on shore and off shore operations, just for the sake of limitation and not by way of any restriction. The connecting system in accordance with the present invention is applicable in respect of all types of applications for joining pipe ends.

### SUMMARY OF THE INVENTION

Thus a combined hub joint and connector arrangement of the introductory said kind is provided, which is distinguished in that the hub end mating surfaces diverge at least over some area of said mating surfaces and opens up in a radially outwards direction.

In one embodiment one of the hub end mating surfaces are plane while the other is diverging from the plane one.

In another embodiment, at least one of the hub end surfaces has an inner plane section, a curved transitional section and an outer inclined section.

In one embodiment the curved transitional section can have an elliptical or circular curvature when viewed in cross section (FIG. 2).

The outer inclined section can be flat or plane.

In a preferable embodiment at least one of the hub end surfaces has a groove for receipt of a sealing ring or gasket. The groove can be located in the curved transitional section.

Preferably a sealing ring is located internally in said hub joint, preferably a metal to metal seal.

The tubular members can be marine risers.

In another embodiment the hub end surface of each of said hubs are respectively provided with a projecting circumferential edge and a complementary cone in order to be guided into each other during mating thereof.

The circumferentially acting connector can either be a clamp connector, collet connector or split ring connector, as required for a particular usage, and of a per se well known design in the industry.

By using such circumferentially acting connector, “point loads” are avoided where the bolts are located in a regular flanged bolt connector, and the loadings are in stead distributed evenly around the circumference.

### BRIEF DESCRIPTION OF THE ACCOMPANYING FIGURES

Having described the main features of the invention above, a more detailed and non-limiting description of two preferred embodiments of the invention will follow with reference to the drawings, in which:

FIG. 1 is a sectional view of a first preferred embodiment of the connecting arrangement according to the present invention,

FIG. 2 is an enlarged and more detailed view of a portion of the connecting arrangement according to the embodiment shown in FIG. 1,

FIG. 3a is a detailed view of a second preferred embodiment of the connecting arrangement according to the present invention, and

FIG. 3b is an enlarged and more detailed view of the portion marked “C” in FIG. 3a.

### DETAILED DESCRIPTION OF THE INVENTION

The following provides a detailed non-limiting description of two preferred embodiments of the connecting arrangement according to the present invention which are purely exemplary.

As shown in figure two pipes 1, 2 are to be connected by the pipe connecting arrangement according to the present invention, at the flanged ends 1′, 2′, also called the hubs. A tubular ring type gasket 5 is disposed on the sealing surfaces 6 of the pipes 1, 2. It is known to persons skilled in the art that the gasket 5 seals the joint designed for connecting the flanged pipe ends 1′, 2′. This is supposed to prevent any sort of leakage. In other words, the main purpose of the gasket 5 is to ensure a leak tight connection of the flanged ends 1′, 2′ of the pipes 1, 2.

A clamp 3, which may be a clamp connector, a collet connector, or split ring connector, acts on the respective outer tapered, or conical, surfaces 4 of the flanged pipe ends 1′, 2′, which in turn causes the two pipe ends to firmly abut, This results in sealing of the pipe ends by means of the gasket 5. Thus, on respective inner sealing surfaces 6, no gap is left ensuring a perfect connection between the two flanged ends 1′, 2′ of the pipes 1, 2.

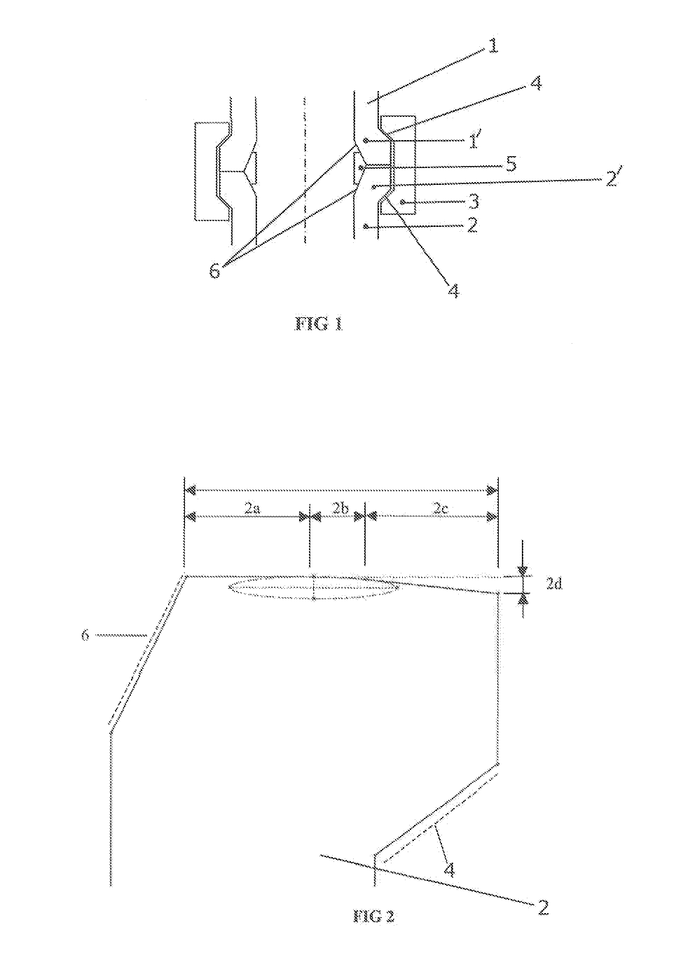

The description above of FIG. 1 explains the, basic principle of connecting flanged pipe ends to ensure prevention of leakage through gaps at the pipe ends, The present invention is explained in detail hereinafter, with reference to the subsequent figures, where like reference numerals represent same constructional features.

FIG. 2 clearly illustrates that at least one of the flanged pipe ends 1′, 2′ have an inner plane or flat section 2a near the inner perimeter of the pipe end, an intermediate curved, such as elliptical or circular, section 2b, followed by an outer plane or flat section 2c. The outer flat section 2c is disposed at an angle, to the first flat section 2a as clearly shown and indicated by 2d.

The construction described in the above paragraph constitutes the main significance of the present invention. When the clamp 3 is tightened, by such as a bolt arrangement (not shown), the radially diverging profile of the pipe end surfaces facilitates concentrating the pretension force from the clamp 3 near the inner perimeter of the flanged pipe ends 1′, 2′, in the vicinity of the sealing surfaces 6. This ensures static sealing conditions, at higher loads than earlier arrangements, which is the principal objective of the present invention. The intermediate portion 2b, by virtue of its rounded configuration, prevents any stress concentration when the clamp 3 is applied.

It should he understood to persons skilled in the art that the above configuration may be provided on either one of the flanged pipe ends 1′, 2′ or on both, which are to be adjoined in abutting relation. either case, the desired results would be achieved. The pipe ends to be adjoined may have extended flanges (not shown) for effecting this configuration. To be precise, in that event the face of at least one or both the flanges may have such configuration. Naturally, in such an arrangement, the pipe ends need not be flared to have the configuration.

The offset 2d as shown in FIG. 2 is determined by FEA (finite element analysis) to be fully or partially eliminated/closed by the pretension force from the clamp connector 3. In some cases the two flanged pipe ends 1′, 2′ shown in FIG. 1, have different geometries depending upon seal retaining interface in the pipe ends 1′, 2′.

When the clamp connector 3 is closing, the segments of the clamp are stretched while the hubs are compressed. When an outer load is applied, the segments are further stretched. Then they will clamp less on the hubs such that the compression thereof is reduced. Eventually, a point is reached where the segments are stretched so much that there is no contact between the hub ends any more. Having entirely plane abutting contact surfaces the contact between the hubs over the entire contact surfaces are lost relatively early. The advantage with the curved or “conical” contact surfaces is that the segments can be stretched beyond the point where the hubs start to loose contact uttermost of the conical surface at the same time as the contact between the hubs at the inner flat contact surface is maintained

It should be understood. to persons skilled, in the art. that the present invention has been described with reference to only two pipes. Occasionally there may be a number of pipes connected one after the other, by applying the technology as described above, and such arrangement fans within the scope of the present invention.

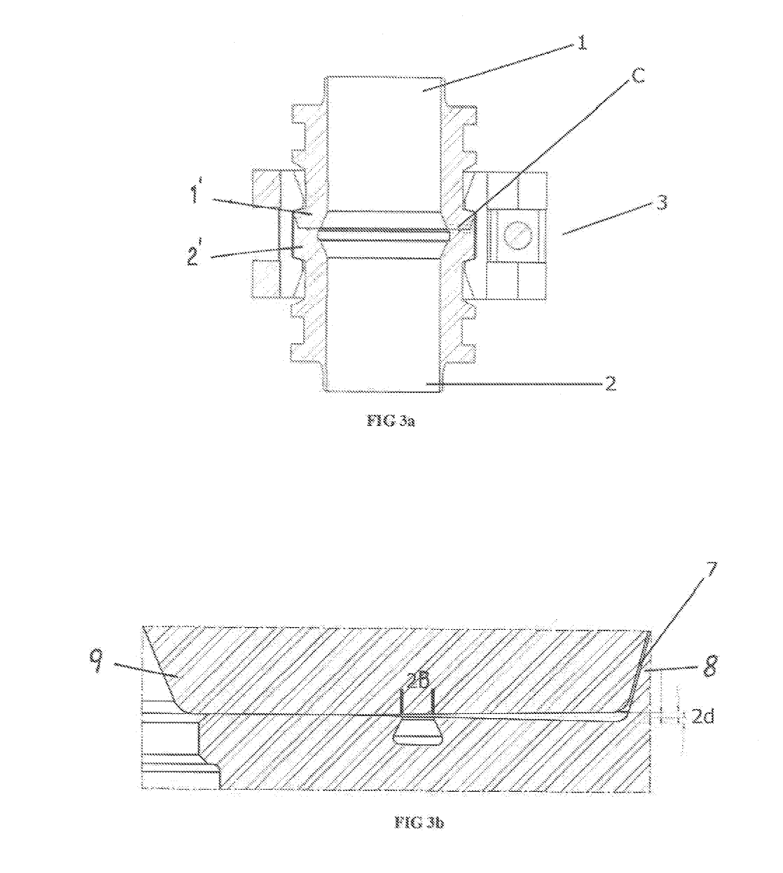

FIG. 3a illustrates another preferred embodiment of the present invention. FIG. 3a shows in cross section the female tapered or conical face of the clamp 3 tightening over the male tapered or conical face of the hubs, for sealing the flanged pipe ends so as to have no separation at adjoined ends.

FIG. 3b illustrates an enlarged view of the portion C marked in FIG. 3a. This shows similar constructional feature as shown in FIG. 2 and works in an identical manner. As shown, a projecting edge 8 is provided on one hub 2′, and a complementary cone 9 is provided on the other hub 1′, The gap or deviation 7, which is not present in the embodiment shown in FIGS. 1 and 2, facilitates proper guiding and alignment between the respective hubs during a connecting operation. The gap indicated by arrows at 2d can be like 1 mm, without this being any limitation.

An annular groove 2b is provided in the lower surface, which groove 2b is adapted to receive a sealing ring of suitable material, either it be of a metallic material or an elastomeric sealing ring.

From the foregoing description and also from the appended claims, it would be clear to persons skilled in the art, that all the objectives of the present invention are achieved. The technology in accordance with the present invention can be applied both in deep and shallow waters and be used irrespective of the underwater conditions. Further, as clarified before, the present invention is applicable in respect of all types of application involving joining of pipe ends.

The present invention has been described with reference to preferred embodiments and drawings for the sake of understanding only and it should be clear to persons skilled in the art that the present invention includes all legitimate modifications within the ambit of what has been described hereinbefore and claimed in the appended claims.

1. A combined hub joint and circumferentially acting connector arrangement for rigidly connecting two axially consecutive tubular members having respective hub end surfaces to be mated, each hub further comprises a flange having an external tapered activation surface adapted for complementary engagement with an internal tapered activation surface of the connector, said activation surfaces being able to transform a transversally acting force, when viewed in the longitudinal direction of the joined hubs, to an axially acting force when the connector is activated to make up the joint, wherein the hub end mating surfaces diverge at least over some area of said mating surfaces and diverge, or opens up, in a radially outwards direction.

2. The combined hub joint and connector arrangement according to claim 1, wherein one of the hub end mating surfaces is planar and extends perpendicular to the axial direction, while the other heb end mating surface diverges from the planar hub end mating surface.

3. The combined hub joint and connector arrangement according to claim 1, wherein at least one of the hub end surfaces has an inner planar section, a curved transitional section and an outer inclined section.

4. The combined hub joint and connector arrangement according to claim 3, wherein the curved transitional section is has an elliptical or circular curvature when viewed in cross section.

5. The combined hub joint and connector arrangement according to claim 3, wherein the outer inclined section is flat or planar.

6. The combined hub joint and connector arrangement according to claim 1, wherein at least one of the hub end surfaces has a groove for receipt of a sealing ring or gasket.

7. The combined hub joint and connector arrangement according to claim 6, wherein at least one of the hub end surfaces has an inner planar section, a curved transitional section and an outer inclined section, and said groove is located in the curved transitional section.

8. The combined hub joint and connector arrangement according to claims 1, wherein a sealing ring is located internally in said hub joint.

9. The combined hub joint and connector arrangement according to claims 1, wherein said tubular members are marine risers.

10. The combined hub joint and connector arrangement according to claim 1, wherein the hub end surface of each of said hubs are respectively provided with a projecting circumferential edge and a complementary cone in order to be guided into each other during mating thereof.

11. The combined hub joint and connector arrangement according to claim 1, wherein the circumferentially acting connector is either a clamp connector, collet connector or split ring connector.

12. The combined hub joint and connector arrangement according to claim 3, wherein the outer inclined section is flat or planar and includes a projecting edge.

13. The combined hub joint and connector arrangement according to claim 1, wherein a metallic sealing ring is located internally in said hub joint to form a metal to metal seal.

14. The combined hub joint and connector arrangement according to claim 2, wherein at least one of the hub end surfaces has an inner planar section, a curved transitional section and an outer inclined section.

15. The combined hub joint and connector arrangement according to claim 2, wherein at least one of the hub end surfaces has a groove for receipt of a sealing ring or gasket.

16. The combined hub joint and connector arrangement according to claim 3, wherein at least one of the hub end surfaces has a groove for receipt of a sealing ring or gasket.

17. The combined hub joint and connector arrangement according to claim 4, wherein at least one of the hub end surfaces has a groove for receipt of a sealing ring or gasket.

18. The combined hub joint and connector arrangement according to claim 5, wherein at least one of the hub end surfaces has a groove for receipt of a sealing ring or gasket.

19. The combined hub joint and connector arrangement according to claim 2, wherein a sealing ring is located internally in said hub joint.

20. The combined hub joint and connector arrangement according to claim 3, wherein a sealing ring is located internally in said hub joint.
